(19) United States
(12) Patent Application Publication
(10) Pub. No.: US 2023/0047076 A1
(43) Pub. Date: Feb. 16, 2023

(54) DEPLOYABLE ELECTRIC VEHICLE CHARGING POINT

(71) Applicant: Albright Product Design Limited, Gloucestershire (GB)

(72) Inventor: Andrew Aylesbury, Gloucestershire (GB)

(21) Appl. No.: 17/792,469

(22) PCT Filed: Jan. 13, 2021
(86) PCT No.: PCT/GB21/50075

§ 371 Date: Jul. 13, 2022

(30) Foreign Application Priority Data
Jan. 13, 2020 (GB) 2000469.3

(51) Int. Cl. B60L 53/16; B60L 53/35; B60L 53/31

(52) U.S. Cl. CPC B60L 53/16; B60L 53/35; B60L 53/31

(57) ABSTRACT

A deployable electric vehicle charging point comprising a housing for burying substantially below ground level, a post and a power distribution connector mounted to the post; the post being mounted in the casing about a pivotal axis and movable about the pivotal axis between an in-operative position within the housing and operative position.

The present invention relates to a deployable electric vehicle charging point.

### BACKGROUND TO THE INVENTION

It is known to provide electric charging points for electric vehicles. These points are typically installed in a street, at home, an industrial area or at a service area, for example, at a motorway service station. Councils also install charging points in carparking areas in towns.

Sometimes it is beneficial to provide a charging point which is stored underground, when not being used, and which deploys to an above ground position for use. This is beneficial to reduce visual street clutter. Furthermore, this removes a permanent fixture, which may be regarded as an obstacle to pedestrians and traffic. Often, charging points are used overnight, and so there is an advantage in being able to store the charge point underground when not in use.

Storing a charge point underground when not in use also reduces the risk of vandalism or damage caused by a collision.

A problem of existing deployable electric vehicle charging points is that they deploy vertically from their base or underground containment. Typically, the charging connection is provided on a post, which is driven upwardly out of the ground from the base unit. This means that if the charging point is situated on a sloping surface, be it a road or pavement, then the charging point will not deploy vertically, but at an angle. If it is to be deployed vertically, then this creates difficulties in installing the base unit.

A further difficulty with installing the base unit is the depth at which excavations have to be made to accommodate the base unit. There are many existing groundworks, such as utility conduits, cables or sewers, which may have to be disturbed or prevent a deployable charging point from being installed.

Furthermore, the cabling to the charging components has to be routed around the base unit. The cables may be forced to move or bend thought tight angles which is particularly problematic for higher capacity charging as the cables are much larger in diameter and more rigid.

It is an object of the present invention to reduce or substantially obviate the aforementioned problems.

### STATEMENT OF INVENTION

According to the present invention there is provided a deployable electric vehicle (EV) charging point comprising a housing for burying substantially below ground level, a post and a power distribution connector mounted to the post; the post being mounted in the housing about a pivotal axis and movable about the pivotal axis between an in-operative position within the housing and operative position, wherein the post is substantially deployed vertical in the operative position irrespective of the incline of the housing for enabling the electric vehicle charging point to be installed on an incline.

Advantageously, if the housing is buried and lies flush with the ground surface, for example on a street which is not level, ie on a hill, then it is possible to ensure that the post, in its operative position, is substantially plumb (or vertical) while also removing unnecessary street furniture and visual clutter. In the operative position, the post may be substantially vertical irrespective of the incline of the housing to the horizontal and the ground level.

The post may generally be considered a pivotally deployable post.

The deployable EV charging point may include a drive means to move the post between the in-operative and operative positions.

The drive means may include an electric motor.

The drive means may include a linear actuator.

The deployable EV charging point may include a transmission means between the drive means and the post. The transmission means may include a worm drive.

Transmission means may be provided for enabling the speed of post deployment to be controlled. Additionally, by the worm drive being self-locking, it is possible to hold the operative position of the post at the desired angle. For example, the worm-drive may be stopped in a particular position.

The central axis of the power distribution connector may be positioned at an angle to the post. The angle may be between 20 degrees and 70 degrees, preferably between 30 and 60 degrees, and more preferably between 40 and 50 degrees.

An angled power distribution connector may serve to reduce the stress on the connected cable, particularly thicker cables used for fast charging. Furthermore, it is easier and more intuitive than horizontal or vertical connections.

A plate may be provided for covering the casing when the post is in the operative position.

The plate may automatically cover the basing when the post is in the operative position. The plate may move from a position within the casing to a position at the upper end of the casing as the post moves from the inoperative to the operative position and vice versa.

Advantageously, the plate may cover an opening at street level which may reduce risk and improve health and safety. It may also ensure that foreign matter, such as leaves, refuse and similarly sized items may not be able to enter the housing.

A mechanical coupling means may be provided between the post and the plate to move the plate from the position within the casing to a position at the upper end of the casing as the post moves from the inoperative to the operative position and vice versa.

The upper end of the casing being the end closest to the surface when the housing is buried. In other words, the upper end being the end of the casing comprising an opening out of which the post is pivotally deployed.

The coupling means may include an arm pivotally attached to the post. The arm may comprise a pin for locating in elongate recess in the plate.

The operative position of the post is generally vertical and may be perpendicular or at another angle, acute or obtuse relative to the upper edge of the housing, dependent on the lie of the ground relative to the horizontal.

The length of the housing may be greater than the height of the housing. When buried, the housing may extend further laterally than in depth below the ground.

The housing may generally be cuboid in shape with an opening in one of the faces.

The deployable EV charging point may be a connected device. The deployable EV charging point may comprise a communication means for communicating with a computer network. The communication means allows the charging point to be monitored remotely.

The deployable EV charging point may comprise an impact detection means for detecting, measuring and recording a received impact. The impact detection means may be an accelerometer.

The deployable EV charging point may comprise an alarm means for altering person within the vicinity. The alarm means may include a speaker. The alarm means may include illumination means, such as LEDs.

The deployable EV charging point comprises a heater for warming the post and/or housing/casing.

The deployable EV charging point may comprises an air pollution sensor.

The deployable electric vehicle charging point may comprise a monitoring means for monitoring the area around the deployable electric vehicle charging point.

The monitoring means may include a camera disposed in the post. The camera may be an omnidirectional camera or include a wide field of view. A first camera may be disposed on the post so as to provide a view external to the deployable EV charging point when the post in in the in-operative position.

The monitoring means may include a microphone. The monitoring system may include an array of microphones disposed in the post and/or the housing/casing.

The deployable EV charging point may comprise a charging cable holding means disposed on the post for securing at least a portion of the electric vehicle charging cable.

### BRIEF DESCRIPTION OF THE DRAWINGS

For a better understanding of the present invention, and to show more clearly how it may be carried into effect, reference will now be made by way of example only to the accompanying drawings, in which:

FIG. 1 shows a perspective view of an electric vehicle charging point in a deployed position ready for charging a vehicle;

FIG. 2 shows a perspective view of the electric vehicle charging point of FIG. 1 in a retracted position below ground;

FIG. 3A shows a perspective view of a second embodiment of an electric vehicle charging point in a retracted position below ground;

FIG. 3B shows a perspective view of the electric vehicle charging point of FIG. 3A in a partially extended position, between the deployed and operative positions; and

FIG. 3C shows a perspective view of the electric vehicle charging point of FIG. 3A in a deployed position ready for charging a vehicle.

### DESCRIPTION OF PREFERRED EMBODIMENTS

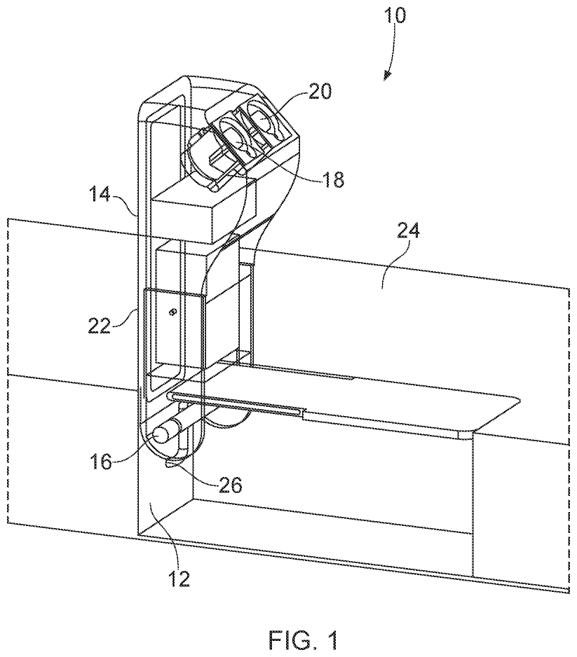

Referring firstly to FIG. 1, a deployable electric vehicle (EV) charging point is indicated generally at 10. The charging point 10 is shown in a deployed position. The charging point 10 includes a housing 12 and a charging post 14. The housing 12 is a substantially rectangular box, preferably made of metals or a composite, which is rigid and can be concreted into the ground.

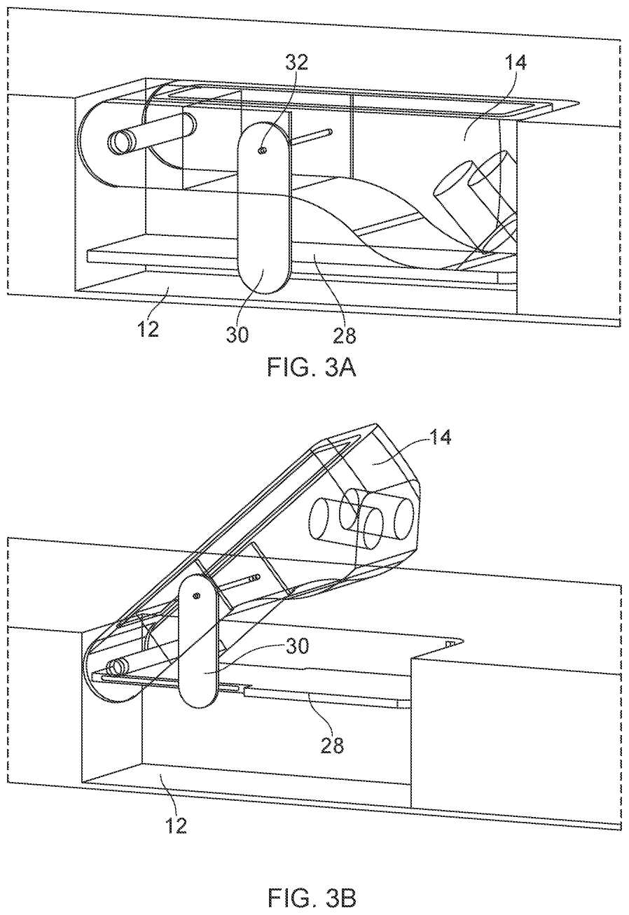

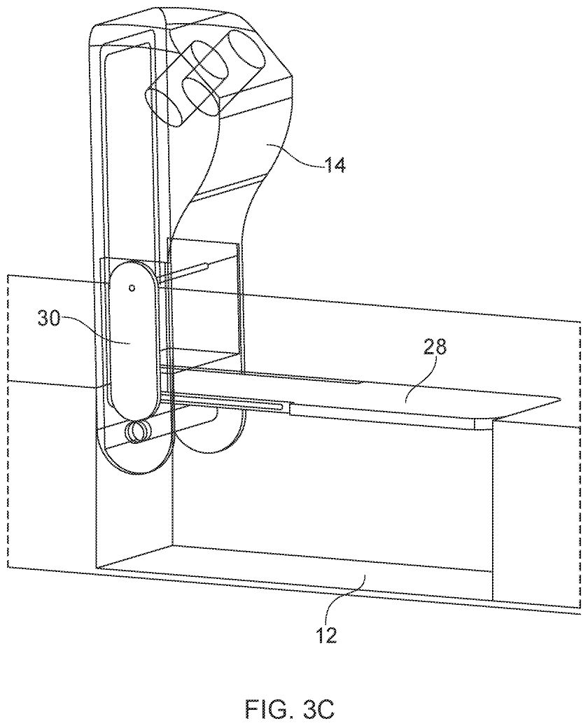

The post 14 is mounted to the housing 12 about an axle 16, providing a pivot, around which the post can move in and out of the housing 12, as indicated in FIGS. 3A to 3C. The axle is mounted to side walls of the housing.

The upper end of the post 14 is provided with an angled surface, for example at around 45 degrees to a central axis of the post. First and second charging sockets, or power distribution connection points, 18,20 are provided in the surface. The sockets are for receiving plugs of EV charging cables.

The angled position of the sockets facilitates easy connection of plugs with the sockets 18,20. Furthermore, a cable supplying power within the post 14 can be easily routed without significant bending.

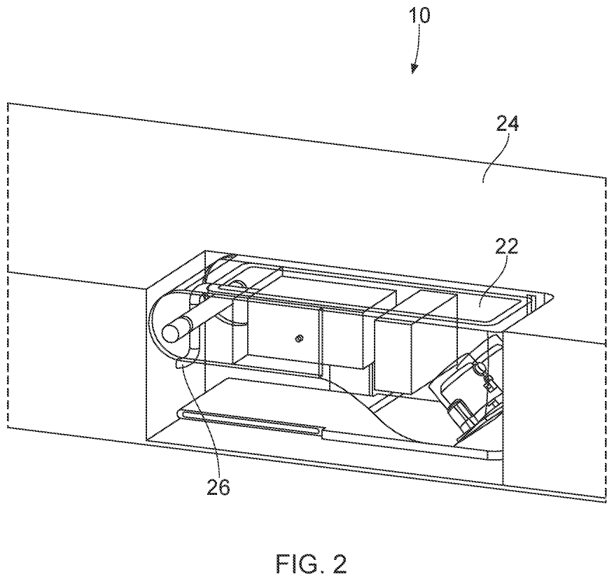

When the post 14 is in the stored position, as shown in FIG. 2, a rear side 22 of the post lies flush with upper edges of the housing 12 and level with the surrounding ground surface, indicated at 24. The rear side 22 is intended to be weight bearing, and a person, for example, can walk onto it, for example, if it is in a pavement or walkway.

In the deployment of the post 14, a power supply cable 26, only has to bend to facilitate the rotary movement at the base of the post about the pivot. The maximum angle of rotation is 90 degrees, but will be reduced on a sloping surface by the angle of the surface to the horizontal. The housing is generally positioned with the pivot point at a lower point on the slope, to minimise the movement of the post and cable 26.

Deployment of the post 14 and movement of the post 14 to the retracted position is powered by an electric motor and a worm drive, which can be controlled remotely using a key fob. Alternatively, the post 14 may be controlled using an application on a mobile device, such as a telephone. Control electronics ensure that the post rotates to the vertical position, irrespective of the angle of the housing 12 in the ground. This position may be detected by a sensor or may be programmed on installation. In this position, the rear side 22 of the post is vertically disposed.

In order to prevent freezing of the axle 16, heating elements may be disposed inside the casing 12. The heating elements may be thermostatically controlled, or may be controlled using the key fob, as part of the actuation control.

A housing cover plate 28 is located in the base of the housing 12 when the post is in the inoperative position (FIG. 3A). This cover plate 28 rises up with the post to the top of the housing 12, as the post is deployed. The cover plate covers the space vacated by the post 14 in the housing 12, for security and safety. A link arm 30, for example, can synchronously lift the cover plate 28 as the post rotates. The link arm is connected to the post 14 about a pivot 32 and is connected to the cover plate by a pin and slot arrangement. Link arms may be provided on both sides of the post to add stability to the plate when deployed, as desired. Releasable securing means, such as latches, can be utilised to further support the periphery of the cover plate 28 in its upper position.

It will be appreciated that the pivotal deployment of the charging point is beneficial because the ground depth of the housing can be limited, for example to around 300 mm, and the height of the post is not compromised. Furthermore, the post 14 can deploy vertically, irrespective of the angle of the ground surface 24, with minimal rotational movement, typically less than 90 degrees, which reduces stress on the cabling.

The charging post 10, may also have lights, one or more cameras, a microphone and other sensing equipment mounted to it for illumination, surveillance and damage detection purposes. This equipment may be connected to a network as part of a wider surveillance network. In particular, an accelerometer may be installed proximate the top of the post for detection of a vehicle impact. Detection of an impact may shut off the power supply to the post.

The embodiments described above are provided by way of example only, and various changes and modifications will be apparent to persons skilled in the art without departing from the scope of the present invention as defined by the appended claims.

What is claimed is:

1. A deployable electric vehicle charging point comprising a housing for burying substantially below ground level, a post and a power distribution connector mounted to the post; the post being mounted in the housing about a pivotal axis and movable about the pivotal axis between an in-operative position within the housing and operative position, wherein the post is substantially deployed vertical in the operative position irrespective of the incline of the housing to the horizontal and the ground level for enabling the electric vehicle charging point to be installed on an incline.

2. The deployable electric vehicle charging point as claimed in claim 1, in which an electric motor drives the post between the in-operative and operative positions.

3. The deployable electric vehicle charging point as claimed in claim 1, in which a central axis of the power distribution connector is positioned at an angle to the post of between 20 degrees and 70 degrees.

4. The deployable electric vehicle charging point as claimed in claim 3, in which the angle is between 30 and 60 degrees.

5. The deployable electric vehicle charging point as claimed in claim 4, in which the angle is between 40 and 50 degrees.

6. The deployable electric vehicle charging point as claimed in any claim 1, in which a plate is provided for covering the housing when the post is in the operative position.

7. The deployable electric vehicle charging point as claimed in claim 6, in which the plate moves from a position within the housing to a position at the upper end of the housing as the post moves from the inoperative to operative position and vice versa.

8. The deployable electric vehicle charging point as claimed in claim 1, in which the post, in its operative position, is at a predetermined angle to a plane formed by the upper end of the housing.

9. The deployable electric vehicle charging point as claimed in claim 8, in which the post, in its operative position, is at an acute angle to a plane formed by the upper end of the housing.

10. The deployable electric vehicle charging point as claimed in claim 8, in which the post, in its operative position, is at an obtuse angle to a plane formed by the upper end of the housing.

11. The deployable electric vehicle charging point as claimed in claim 8, in which the post, in its operative position, is perpendicular to a plane formed by the upper end of the housing.

12. The deployable electric vehicle charging point as claimed in claim 1, in which the length of the housing is greater than the height of the housing.

13. The deployable electric vehicle charging point as claimed in claim 1, comprising a communication means for communicating with a network.

14. The deployable electric vehicle charging point as claimed in claim 1, comprising an impact detection means for detecting, measuring and recording a received impact.

15. The deployable electric vehicle charging point as claimed in claim 1, comprising an alarm means for alerting person within the vicinity.

16. The deployable electric vehicle charging point as claimed in claim 1, in which a heater is provided for warming the post and/or housing.

17. The deployable electric vehicle charging point as claimed in claim 1, in which an air pollution sensor is provided.

18. The deployable electric vehicle charging point as claimed in claim 1, in which a monitoring means is provided for monitoring the area around the deployable electric vehicle charging point.

19. The deployable electric vehicle charging point as claimed in claim 1, in which a charging cable holding means is provided for securing at least a portion of the electric vehicle charging cable.
